(19) United States
(12) Patent Application Publication
(10) Pub. No.: US 2025/0190761 A1
(43) Pub. Date: Jun. 12, 2025

(54) Generation of Video for a Location Via a Generative Machine-Learned Model

(71) Applicant: Google LLC, Mountain View, CA (US)

(72) Inventors: Daniel Joseph Filip, San Jose, CA (US); Charles Goran, Lafayette, CO (US)

(21) Appl. No.: 18/532,392

(22) Filed: Dec. 7, 2023

(51) Int. Cl. G06N 3/0455; G06F 40/40; G06T 15/10

(52) U.S. Cl. CPC G06N 3/0455; G06F 40/40; G06T 15/10

(57) ABSTRACT

A computer platform for generating a video includes one or more memories to store instructions and one or more processors to execute the instructions to perform operations, the operations including: receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user.

### FIELD

The disclosure relates generally to providing an immersive video relating to a location via a generative machine-learned model. For example, the disclosure relates to methods and systems for providing an immersive video relating to a location via a generative machine-learned model in response to a user query relating to the location.

### BACKGROUND

Current rendering engines render three-dimensional (3D) scenes to create and display 3D graphics in real-time. A virtual camera, which may be controllable by a user, can change a viewpoint of the scene, the changed viewpoint being rendered in real-time by the rendering engine.

### SUMMARY

Aspects and advantages of embodiments of the disclosure will be set forth in part in the following description, or can be learned from the description, or can be learned through practice of the example embodiments.

In one or more example embodiments, a computer platform for generating a video is provided. For example, the computer platform for generating a video includes: one or more memories configured to store instructions; and one or more processors configured to execute the instructions to perform operations, the operations comprising: receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user.

In some implementations, the generative machine-learned model comprises a neural radiance field (NeRF).

In some implementations, generating the conditioning parameters comprises retrieving current values for the one or more conditions at the location.

In some implementations, generating, using the generative machine-learned model, the video comprises conditioning the generative machine-learned model with the conditioning parameters.

In some implementations, generating the conditioning parameters comprises extracting the values for the one or more conditions from the query.

In some implementations, generating the conditioning parameters comprises inferring the values for the one or more conditions from the query.

In some implementations, inferring the values for the one or more conditions comprises providing the query to a sequence processing model, wherein the sequence processing model is configured to output the values for the one or more conditions in response to the query.

In some implementations, the operations include implementing one or more large language models to determine a plurality of variables based on the query.

In some implementations, generating the conditioning parameters comprises predicting future values for the one or more conditions based on current values for the one or more conditions at the location and/or based on historical values for the one or more conditions at the location.

In some implementations, generating, using the generative machine-learned model, the video comprises: generating a series of camera poses based at least in part on the query; and rendering, respectively from the series of camera poses, a series of images of the scene at the location and with the values for the one or more conditions.

In some implementations, the computer platform further comprises a database configured to store a plurality of generative machine-learned models respectively associated with a plurality of different locations; and generating, using the generative machine-learned model, the video comprises retrieving, from among the plurality of generative machine-learned models, the generative machine-learned model associated with the location.

In some implementations, the query comprises a text query that specifies one or more objects to be included in the scene and wherein the video depicts the one or more object included in the scene.

In some implementations, the generative machine-learned model has been trained on a training dataset comprising a plurality of reference images of the location, and the training dataset comprises values for the one or more conditions for at least some of the plurality of reference images.

In some implementations, the operations further comprise: receiving a further query from the user relating to the video; in response to receiving the further query, generating further conditioning parameters based at least in part on the further query, wherein the further conditioning parameters provide values for one or more further conditions associated with the scene to be rendered at the location; generating, using the generative machine-learned model, an adjusted video, wherein the adjusted video depicts the scene at the location and with the values for the one or more further conditions; and providing the adjusted video for presentation to the user.

In one or more example embodiments, a computer-implemented method for generating a video is provided. The computer-implemented method comprises receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user.

In some implementations, the generative machine-learned model comprises a neural radiance field (NeRF).

In some implementations, generating the conditioning parameters comprises: retrieving current values for the one or more conditions at the location, or predicting future values for the one or more conditions based on current values for the one or more conditions at the location and/or based on historical values for the one or more conditions at the location.

In some implementations, generating the conditioning parameters comprises extracting the values for the one or more conditions from the query.

In some implementations, generating the conditioning parameters comprises inferring the values for the one or more conditions from the query.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations which are associated with any of the methods described herein (e.g., operations of the server computing system and/or operations of the computing device). For example, the operations may include: receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user. The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIGS. 1A-1B depict example systems according to according to one or more example embodiments of the disclosure;

FIG. 2 illustrates a flow diagram of an example, non-limiting computer-implemented method, according to one or more example embodiments of the disclosure;

FIG. 3 depicts example block diagrams of a computer platform, according to one or more example embodiments of the disclosure;

FIGS. 4A-4D illustrate example user interface screens of a mapping or navigation application, according to one or more example embodiments of the disclosure;

FIG. 5A depicts a block diagram of an example computing system for generating a video via a generative machine-learned model in response to receiving a query, according to one or more example embodiments of the disclosure;

FIG. 5B depicts a block diagram of an example computing device for generating a video via a generative machine-learned model in response to receiving a query, according to one or more example embodiments of the disclosure;

FIG. 5C depicts a block diagram of an example computing device for generating a video via a generative machine-learned model in response to receiving a query, according to one or more example embodiments of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

Examples of the disclosure are directed to a computer platform for generating a video (e.g., an immersive video) of a location in response to a query from a user. For example, a user may provide a query to the computer platform relating to the location (e.g., a query such as “show me what the Palace of Fine Arts looks like on a Saturday in August”, or a query such as “what would the Palace of Fine Arts look like with a sea monster in the lagoon”). The query may be provided or input to a navigation application or maps application, for example.

In response to receiving the query, the computer platform may generate conditioning parameters based at least in part on the query, wherein the conditioning parameters provide values for one or more conditions associated with a scene to be rendered at the location. For example, the conditioning parameters may serve as guidance or settings that will influence the generation of the scene to be rendered at the location. In some implementations, the conditioning parameters may include temporal parameters (e.g., a time of day, time of week, time of year, etc.), environmental parameters (e.g., lighting, weather, sound, etc.), contextual parameters (e.g., a particular layout, format, genre, etc.), user-specific parameters (e.g., according to preferences of the user, user-specified content, etc.).

In some implementations, the computer platform may be configured to receive the query, which could be in the form of a question, command, or description. The query may include information which specifies one or more objects to be included in the scene. The computer platform may be configured to use the content of the query as a source of information or context for generating the conditioning parameters. For example, the computer platform may be configured to extract values for one or more conditions from the query. In some implementations, the computer platform may be configured to receive or obtain information from external sources (e.g., an external computing device, a database, a server computing system, etc.) for generating the conditioning parameters. The query may include information indicative of the user's intent or requirements. For example, the computer platform may be configured to infer values for one or more conditions from the query (e.g., the computer platform may be configured to infer that a user's reference to a “crowded bar” may correspond to the bar being at least 80% full compared to a known capacity of the bar).

In some implementations, the computer platform may be configured to generate the conditioning parameters by predicting future values for the one or more conditions based on current values for the one or more conditions at the location and/or historical values for the one or more conditions at the location. For example, the computer platform may obtain current values for the conditions at the location based on real-time sensor data output by sensors which detect information about the location. For example, one or more sensors may be configured to detect a number of people at a location, weather information at the location (e.g., temperature, precipitation, humidity, wind, etc.), lighting conditions at the location, noise levels at the location, etc. For example, the computer platform may obtain historical values for the conditions at the location from a database, server computing system, external computing device, user profile, etc.

In some implementations, the computer platform may be configured to infer the values for the one or more conditions from the query by providing the query to a sequence processing model, wherein the sequence processing model is configured to output the values for the one or more conditions in response to or based on the query. The sequence processing model may be a machine-learned model which is configured to process and analyze sequential data and to handle data that occurs in a specific order or sequence, including time series data, natural language text, or any other data with a temporal or sequential structure.

The conditioning parameters may provide values for one or more conditions associated with a scene to be rendered at the location. For example, the values may relate to various aspects of the scene (e.g., lighting, objects, textures, environmental conditions, etc.) relating to the location. The conditioning parameters may be used to define conditions or attributes of the scene to be generated. For example, the conditions may encompass a wide range of factors, including lighting conditions (day or night), weather conditions (sunny or rainy), object placement, spatial layout, a mood or atmosphere of the scene, etc. For example, the values may be defined based on various scales (e.g., a scale of 0 to 1 corresponding to a level of brightness, transparency, etc.). For example, the values may be defined based on actual values (e.g., a day of the week, a time of day, a speed, a decibel level, etc.).

In some implementations, the computer platform may be configured to retrieve current values for the conditions at the location. For example, the computer platform may obtain current values for the conditions at the location based on real-time sensor data output by sensors which detect information about the location. For example, one or more sensors may be configured to detect a number of people at a location, weather information at the location (e.g., temperature, precipitation, humidity, wind, etc.), lighting conditions at the location, noise levels at the location, etc.

In some implementations, the computer platform may be configured to implement one or more large language models to determine a plurality of variables based on the query. For example, the large language model may include a Bidirectional Encoder Representations from Transformers (BERT) large language model. The large language model may be trained to understand and process natural language for example. The large language model may be configured to extract information from the query to identify keywords, intents, and context within the query to determine a plurality of variables for generating the video. The variables may include latent variables that represent an underlying structure of the language.

For example, the computer platform may be configured to generate, using a generative machine-learned model, a video which depicts the scene at the location and with the values for the one or more conditions.

The generative machine-learned model may include a deep neural network or a generative adversarial network (GAN) to generate the video that depicts the scene at a particular location with values for conditions associated with that scene. For example, the computer platform may include a database configured to store a plurality of generative machine-learned models respectively associated with a plurality of different locations. The computer platform may be configured to retrieve, from among the plurality of generative machine-learned models, the generative machine-learned model associated with the location relating to the query.

In some implementations, the generative machine-learned model may be trained on a large dataset of videos or frames of scenes with corresponding information about the conditions associated with each scene. These conditions could include variables like time of day, weather, lighting, object placement, etc. During training, the generative machine-learned model learns the relationships between the visual elements in the scene and the conditions that influence them. This may involve adjusting the generative machine-learned model's internal parameters to generate realistic scenes based on the training data. the generative machine-learned model may be trained on one or more training datasets including a plurality of reference images of the location. The one or more training datasets may include values for the one or more conditions for at least some of the plurality of reference images.

As described herein, the query may include information relating to the location and values for one or more conditions associated with the scene to be rendered at the location may be used by the generative machine-learned model to generate the video frame by frame. For example, the generative machine-learned model may be configured to generate an initial frame and generate subsequent frames based on the conditions specified. For example, the generative machine-learned model may be configured to generate a series of camera poses based at least in part on the query. For example, the generative machine-learned model may be configured to render, respectively from the series of camera poses, a series of images of the scene at the location and with the values for the one or more conditions. For example, if the query indicates a sunset scene, the generative machine-learned model may be configured to gradually change the lighting, shadows, and colors in the scene to simulate the progression from day to sunset. The video may be formed by a series of images of the scene where at least some of the images may be from different camera poses. The generative machine-learned model may be configured to generate the video by conditioning the generative machine-learned model with the conditioning parameters. For example, the generative machine-learned model may be configured to consider the conditioning parameters (and corresponding values for the one or more conditions) to make decisions for rendering the scene at each frame. For example, the generative machine-learned model may be configured to adjust (for each frame of the video) the position of the sun, the colors of the sky and water, and the placement of objects on the beach, in accordance with the specified conditions, making the scene and video appear realistic and/or coherent. For example, the generative machine-learned model may be configured to continue the frame-by-frame generation process until the entire video sequence has been created. The generative machine-learned model may be configured to output the video that depicts the scene at the location with the values for conditions associated with that scene, matching the criteria provided in the input query and conditioning parameters. In some implementations, the computer platform may be configured to implement post-processing operations to enhance the quality of the video, add special effects, or fine-tune details.

For example, the generative machine-learned model may include a neural radiance field (NeRF). A NeRF may be implemented via a fully-connected neural network to generate novel views of complex 3D scenes, based on a partial set of 2D images to generate 3D representations of an object or scene from 2D images. For example, the fully-connected neural network may be configured to predict the light intensity (or radiance which includes color and lighting) at any point in a 2D image to generate novel 3D views from different angles. For example, the fully-connected neural network may be configured to take input images representing a scene and interpolate between them to render a complete scene.

One or more technical benefits of the disclosure include allowing users to easily and accurately obtain an accurate representation of a state of a location under particular circumstances or conditions by generating a video relating to a location via one or more generative machine-learned models. For example, a user can easily and more accurately obtain an accurate representation of a state of an indoor or outdoor venue including a restaurant or park at a particular time of day, time of day, time of year, etc. For example, a user can easily and more accurately obtain an accurate representation of a state of an indoor or outdoor venue including a restaurant or park under certain environmental conditions (e.g., when it is sunny, when it is rainy, when it is windy, etc.). Due to the above methods, users are provided with an accurate representation of a state of a location, virtually and via a display, without needing to travel to the location in person. Further, the user may also be provided with an accurate prediction of the state of a location at a certain time or under certain conditions, as defined by the user.

The computer platform and methods described herein can provide a location-specific generative video in response to a query relating to a location. The computing platform and methods described herein can further be used to provide a model (e.g., three-dimensional model) of the location (e.g., a point-of-interest) with real-time traffic, crowd size, weather, and/or other contextual or situation-specific information. Furthermore, the computing platform and methods described herein can enable generative videos for map and navigation applications.

Another technical benefit of the computing platform and methods of the disclosure is the dimensionally accurate modeling and the interactivity of the provided rendering. The computing platform can dynamically provide dimensionally accurate representations of locations in response to queries from a user, for example to allow for potential visitors to determine if they indeed wish to travel to the location.

Another example technical effect and benefit relates to improved computational efficiency and improvements in the functioning of a computing platform. For example, certain existing systems involve rendering engines to process and render a three-dimensional model that requires significant computational resources. In contrast, by implementing a generative machine-learned model to generate a video relating to a location, the disclosed computer platform and methods can save computational resources such as processor usage, memory usage, and/or network bandwidth.

Thus, according to aspects of the disclosure, technical benefits such as resource savings and immersive view accuracy improvements may be achieved.

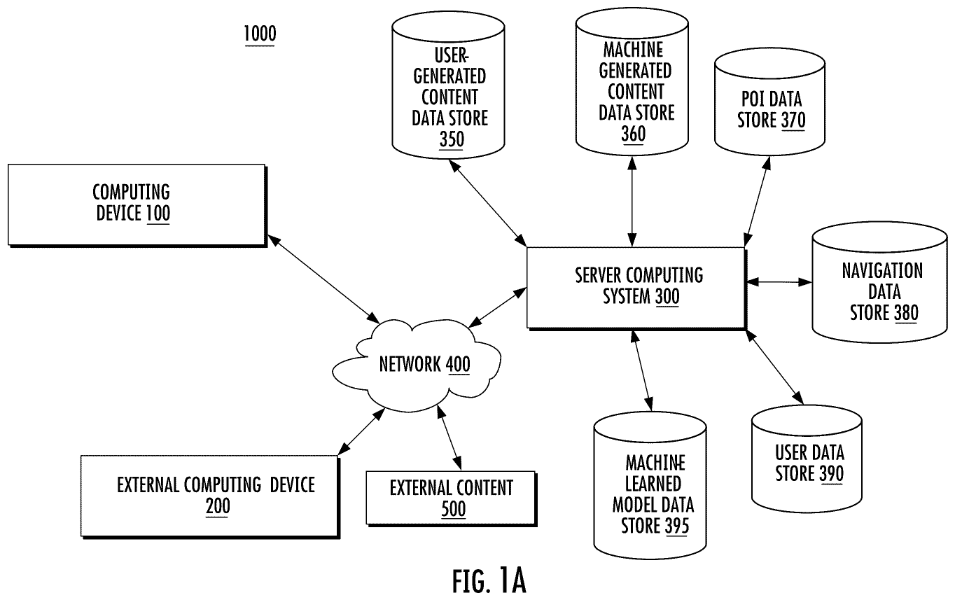

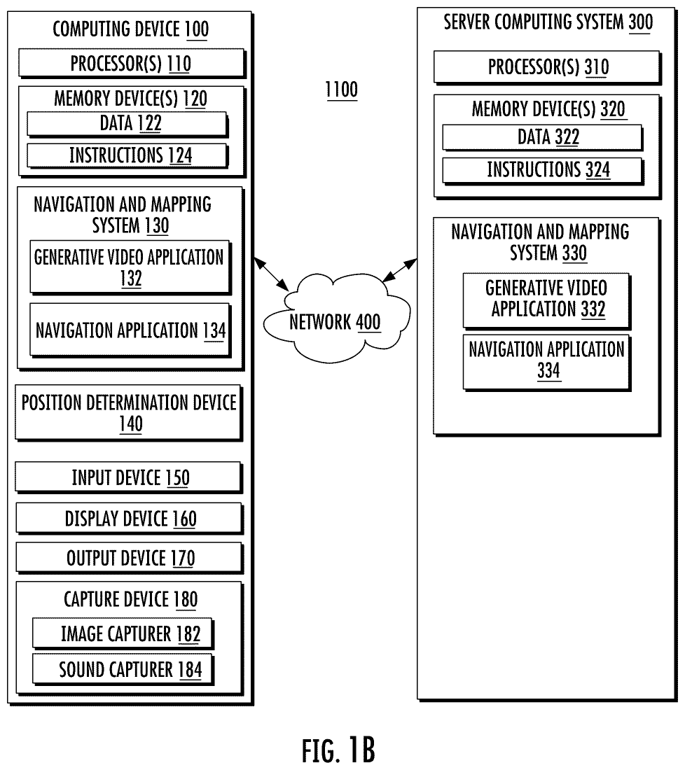

Referring now to the drawings, FIG. 1A is an example system according to one or more example embodiments of the disclosure. FIG. 1A illustrates an example of a system 1000 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of a navigation and mapping system which can provide a video of a location to a user of the computing device 100 via a generative machine-learned model.

In some example embodiments, the server computing system 300 may obtain data from one or more of a user-generated content data store 350, a machine-generated content data store 360, a POI data store 370, a navigation data store 380, a user data store 390, and a machine-learned model data store 395, to implement various operations and aspects of the navigation and mapping system as disclosed herein. The user-generated content data store 350, machine-generated content data store 360, POI data store 370, navigation data store 380, user data store 390, and machine-learned model data store 395 may be integrally provided with the server computing system 300 (e.g., as part of the one or more memory devices 320 of the server computing system 300) or may be separately (e.g., remotely) provided. Further, user-generated content data store 350, machine-generated content data store 360, POI data store 370, navigation data store 380, user data store 390, and machine-learned model data store 395 can be combined as a single data store (database), or may be a plurality of respective data stores. Data stored in one data store (e.g., the POI data store 370) may overlap with some data stored in another data store (e.g., the navigation data store 380). In some implementations, one data store (e.g., the machine-generated content data store 360) may reference data that is stored in another data store (e.g., the user-generated content data store 350).

User-generated content data store 350 can store media content which is captured by a user, for example, via computing device 100, external computing device 200, or some other computing device. The user-generated media content may include user-generated visual content and/or user-generated audio content. For example, the media content may be captured by a person operating the computing device 100 or may be captured indirectly, for example, by a computing system that monitors a location (e.g., a security system, surveillance system, and the like).

For example, the media content may be captured by a camera (e.g., image capturer 182) of a computing device, and may include imagery of a location including a restaurant, a landmark, a business, a school, and the like. The imagery may include various information (e.g., metadata, semantic data, etc.) which is useful for generating video of a location associated with the imagery. For example, an image may include information including a date the image was captured, a time of day the image was captured, and location information indicating the location where the image was taken (e.g., a GPS location), etc. For example, descriptive metadata may be provided with the image and may include keywords relating to the image, a title or name of the image, environmental information at the time the image was captured (e.g., lighting conditions including a luminance level, noise conditions including a decibel level, weather information including weather conditions including temperature, wind, precipitation, cloudiness, humidity, etc.), and the like. The environmental information may be obtained from sensors of the computing device 100 used to capture the image or from another computing device.

For example, the media content may be captured by a microphone (e.g., sound capturer 184) of the computing device 100, and may include audio associated with a location including a restaurant, a landmark, a business, a school, and the like. The audio content may include various information (e.g., metadata, semantic data, etc.) which is useful for generating audio content for a video generated via a generative machine-learned model. For example, the audio content may include information including a date the audio was captured, a time of day the audio was captured, and location information indicating the location where the audio was captured (e.g., a GPS location), etc. For example, descriptive metadata may be provided with the audio and may include keywords relating to the audio, a title or name of the audio, environmental information at the time the audio was captured (e.g., lighting conditions including a luminance level, noise conditions including a decibel level, weather information including weather conditions including temperature, wind, precipitation, cloudiness, humidity, etc.), and the like. The environmental information may be obtained from sensors of the computing device 100 used to capture the audio or from another computing device.

Machine-generated content data store 360 can store machine-generated media content which can be generated by the server computing system 300, for example, or some other computing device. The machine-generated media content may include machine-generated visual content and/or machine-generated audio content. For example, the machine-generated content stored at machine-generated content data store 360 may be generated based on user-generated media content captured by one or more users of computing devices and/or based on synthesized media content which is created by the server computing system 300 or some other computing device.

In some implementations the machine-generated content stored at machine-generated content data store 360 may be generated by converting the user-generated media content to a generic form to anonymize the media content (e.g., by converting a real-world image of a person positioned at a location to a two-dimensional or three-dimensional digital avatar which represents the person). In some implementations machine-generated content stored at machine-generated content data store 360 may be generated based on sensor data obtained by one or more sensors (which may form part of external content 500) disposed at a location. For example, the sensor data obtained by the one or more sensors may indicate how many people are present at a location (e.g., based on the number of smartphones or other computing devices detected at the location). For example, the sensor data obtained by the one or more sensors may indicate various features about the people at the location (e.g., clothing, facial expressions, etc., based on an image captured by a camera, for example). For example, the server computing system 300 (or some other computing system) may generate graphical representations of the people at the location according to the number of people and according to the features about the people at the location, to accurately represent the state of the location. As previously mentioned, the generation of such graphical representations may be based on identifying an object type or characteristic. For example, on determining that the sensor data indicates the object is a person, a graphical representation of a human may be generated. As another example, the sensor data may indicate that the object is a person wearing a hat, in which case a graphical representation of a human wearing a hat may be generated.

In some implementations the server computing system 300 (or some other computing system) may be configured to generate the machine-generated content stored at machine-generated content data store 360 by creating new media content based on a portion of the user-generated media content. For example, the server computing system 300 (or some other computing system) may be configured to generate audio content based on a portion (e.g., granular information) of recorded user-generated audio content or other available sound to create new audio content that remains representative of the mood, atmosphere, vibe, or feeling of the location at a particular time (e.g., time of day, time of week, time of year, etc.). As previously mentioned, the generation of audio content may be based on identifying an audio type or characteristic of the portion of recorded user-generated audio content or other available sound. For example, the user-generated audio content may have an audio type of “country music”, in which case the generated audio content may also be country music in order to accurately represent the state of the location.

POI data store 370 can store information about locations or points-of-interest, for example, for points-of-interest in an area or region associated with one or more geographic areas. A point-of-interest may include any destination or place. For example, a point-of-interest may include a restaurant, museum, sporting venue, concert hall, amusement park, school, place of business, grocery store, gas station, theater, shopping mall, lodging, and the like. Point-of-interest data which is stored in the POI data store 370 may include any information which is associated with the POI. For example, the POI data store 370 may include location information for the POI, hours of operation for the POI, a phone number for the POI, reviews concerning the POI, financial information associated with the POI (e.g., the average cost for a service provided and/or goods sold at the POI such as a meal, a ticket, a room, etc.), environmental information concerning the POI (e.g., a noise level, an ambiance description, a traffic level, etc., which may be provided or available in real-time by various sensors located at the POI), a description of the types of services provided and/or goods sold, languages spoken at the POI, a URL for the POI, image content associated with the POI, etc. For example, information about the POI may be obtainable from external content 500 (e.g., from webpages associated with the POI or from sensors disposed at the POI).

Navigation data store 380 may store or provide map data/geospatial data to be used by server computing system 300. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), and other features of interest. Navigation data store 380 can be used by server computing system 300 to provide navigational directions, perform point of interest searches, provide point of interest location or categorization data, determine distances, routes, or travel times between locations, or any other suitable use or task required or beneficial for performing operations of the example embodiments as disclosed herein.

For example, the navigation data store 380 may store 3D scene imagery which includes images associated with generating 3D scenes and videos of various locations. In an example, server computing system 300 may be configured to generate a 3D scene or video based on a plurality of images of a location (e.g., of the inside of a restaurant, of a park, etc.). The plurality of images may be captured and combined using 3D reconstruction methods, computer vision methods, etc. For example, images which overlap with one another may be stitched together to create a 3D model of the scene. In some implementations, a method including a structure from motion algorithm can be used to estimate a three-dimensional structure. In some implementations, a multi-view stereo method may be implemented to generate a dense 3D point cloud by identifying corresponding points in multiple images and then triangulating their 3D positions. In some implementations, depth sensing methods may be implemented to determine or estimate a depth of each pixel in an image (e.g., using depth-sensing cameras, LiDAR, etc.) to generate depth maps which can be used to create a 3D point cloud or mesh representation of a scene. In some implementations, a machine learning resource (e.g., a neural radiance field) may be implemented to generate a camera-like image from any viewpoint within the location based on the captured images. For example, video flythroughs of the location may be generated based on the captured images. In some implementations, the initial 3D scene may be a static 3D scene which is devoid of variable or dynamic (e.g., moving) objects. For example, the initial 3D scene of a park may include imagery of the park including imagery of trees, playground equipment, picnic tables, and the like, without imagery of humans, dogs, or non-static objects. In some implementations, the initial 3D scene may be a 3D scene which includes one or more variable or dynamic (e.g., moving) objects. User generated content may include imagery of the variable or dynamic objects, where the imagery may be associated with different times and/or conditions (e.g., different times of the day, week, or year, different lighting conditions, different environmental conditions, etc.). In some implementations, one or more machine-learned models may be configured to generate content to be included in a video which is generated by one or more other machine-learned models.

For example, the navigation data store 380 may store videos of various locations. For example, the videos may include videos which have been generated via one or more generative machine-learned models according to a query from a user relating to a location.

In some example embodiments, the user data store 390 can represent a single database. In some embodiments, the user data store 390 represents a plurality of different databases accessible to the server computing system 300. In some examples, the user data store 390 can include a current user position and heading data. In some examples, the user data store 390 can include information regarding one or more user profiles, including a variety of user data such as user preference data, user demographic data, user calendar data, user social network data, user historical travel data, and the like. For example, the user data store 390 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, the data can be analyzed to determine preferences of the user with respect to a POI, for example, to automatically suggest or automatically provide a video of a location that is preferred by the user, where the video is associated with a time that is also preferred by the user (e.g., providing a video of a park in the evening where the user data indicates the park is a favorite POI of the user and that the user visits the park most often during the evening). The data can be analyzed to determine preferences of the user with respect to a POI, for example, to determine preferences of the user with respect to traveling (e.g., a mode of transportation, an allowable time for traveling, etc.), to determine possible recommendations for POIs for the user, to determine possible travel routes and modes of transportation for the user to a POI, and the like.

The user data store 390 is provided to illustrate potential data that could be analyzed, in some embodiments, by the server computing system 300 to identify user preferences, to recommend POIs, to determine possible travel routes to a POI, to determine modes of transportation to be used to travel to a POI, to determine videos of locations to provide to a computing device associated with the user, etc. However, such user data may not be collected, used, or analyzed unless the user has consented after being informed of what data is collected and how such data is used. Further, in some embodiments, the user can be provided with a tool (e.g., in a navigation application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 390 may or may not be accessible to the server computing system 300 based on permissions given by the user, or such data may not be stored in the user data store 390 at all.

Machine-learned model data store 395 can store machine-learned models which can be retrieved and implemented by the server computing system 300 for generating videos as described herein, for example, or by some other computing device. In some implementations, the machine-learned models include a plurality of generative machine-learned models respectively associated with a plurality of different locations. In some implementations, the machine-learned models include a plurality of generative machine-learned models respectively associated with particular objects which are provided at the plurality of different locations. The machine-learned models may include large language models (e.g., Bidirectional Encoder Representations from Transformers (BERT) large language model). The machine-learned models may include generative artificial intelligence (AI) models (e.g., Bard) which may implement generative adversarial networks (GANs), transformers, variational autoencoders (VAEs), neural radiance fields (NeRFs), and the like. The NeRFs may be trained to learn a continuous volumetric scene function, that can assign a color and volume density to any voxel in the space. The NeRF network's weights may be optimized to encode the representation of the scene so that the model can render novel views seen from any point in space.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

Referring now to FIG. 1B, example block diagrams of a computing device and server computing system according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, a navigation and mapping system 130, a position determination device 140, an input device 150, a display device 160, an output device 170, and a capture device 180. The server computing system 300 may include one or more processors 310, one or more memory devices 320, and a navigation and mapping system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can store instructions, that when executed, cause the one or more processors 110 to execute a generative video application 132, and to execute the instructions to perform operations including: receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user, as described according to examples of the disclosure.

One or more memory devices 320 can also include data 322 and instructions 324 that can be retrieved, manipulated, created, or stored by the one or more processors 310. In some example embodiments, such data can be accessed and used as input to implement generative video application 332, and to execute the instructions to perform operations including: receiving a query from a user relating to a location; in response to receiving the query, generating conditioning parameters based at least in part on the query, wherein the conditioning parameters provide values for one or more conditions associated with a scene to be rendered at the location; generating, using a generative machine-learned model, the video, wherein the video depicts the scene at the location and with the values for the one or more conditions; and providing the video for presentation to the user, as described according to examples of the disclosure.

In some example embodiments, the computing device 100 includes a navigation and mapping system 130. For example, the navigation and mapping system 130 may include a generative video application 132 and a navigation application 134.

According to examples of the disclosure, the generative video application 132 may be executed by the computing device 100 to provide a user of the computing device 100 a way to explore a location through a video which provides various multi-dimensional views of an area or point-of-interest including landmarks, restaurants, and the like. In some implementations, the generative video application 132 may provide a video flythrough of an interior of a location to provide a user an inside view of a location, a video flythrough of an outdoor location, a video from an overhead viewpoint of a location, etc. The generative video application 132 may be part of navigation application 134 or a separate mapping application, or may be a standalone application. The generative video application 132 may be configured to be dynamically interactive according to various user inputs. For example, the generative video application 132 may be configured to change a viewpoint of a video from a first viewpoint to a second viewpoint according to a user input (e.g., a voice input which requests that an object in the video be shown from a different angle or perspective). The generative video application 132 may be configured to dynamically generate the video relating to the location (e.g., in real-time) according to various user inputs. Further aspects of the generative video application 132 will be described herein.

In some examples, one or more aspects of the generative video application 132 may be implemented by the generative video application 332 of the server computing system 300 which may be remotely located, to generate and/or provide a video in response to receiving a query from a user. In some examples, one or more aspects of the generative video application 332 may be implemented by the generative video application 132 of the computing device 100, to generate and/or provide a video in response to receiving a query from a user.

According to examples of the disclosure, the navigation application 134 may be executed by the computing device 100 to provide a user of the computing device 100 a way to navigate to a location. The navigation application 134 can provide navigation services to a user. In some examples, the navigation application 134 can facilitate a user's access to a server computing system 300 that provides navigation services. In some example embodiments, the navigation services include providing directions to a specific location such as a POI. For example, a user can input a destination location (e.g., an address or a name of a POI). In response, the navigation application 134 can, using locally stored map data for a specific geographic area and/or map data provided via the server computing system 300, provide navigation information allowing the user to navigate to the destination location. For example, the navigation information can include turn-by-turn directions from a current location (or a provided origin point or departure location) to the destination location. For example, the navigation information can include a travel time (e.g., estimated or predicted travel time) from a current location (or a provided origin point or departure location) to the destination location.

The navigation application 134 can provide, via a display device 160 of the computing device 100, a visual depiction of a geographic area. The visual depiction of the geographic area may include one or more streets, one or more points of interest (including buildings, landmarks, and so on), and a highlighted depiction of a planned route. In some examples, the navigation application 134 can also provide location-based search options to identify one or more searchable points of interest within a given geographic area. In some examples, the navigation application 134 can include a local copy of the relevant map data. In other examples, the navigation application 134 may access information at server computing system 300 which may be remotely located, to provide the requested navigation services.

In some examples, the navigation application 134 can be a dedicated application specifically designed to provide navigation services. In other examples, the navigation application 134 can be a general application (e.g., a web browser) and can provide access to a variety of different services including a navigation service via the network 400.

In some example embodiments, the computing device 100 includes a position determination device 140. Position determination device 140 can determine a current geographic location of the computing device 100 and communicate such geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may further include a haptic device to provide haptic feedback to a user. The input device 150 may also be embodied by a touch-sensitive display having a touchscreen capability, for example. For example, the input device 150 may be configured to receive an input from a user associated with the input device 150.

The computing device 100 may include a display device 160 which displays information viewable by the user (e.g., a map, an immersive video of a location, a user interface screen, etc.). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the navigation and mapping system 130 provided at the computing device 100 to display information to a user relating to an input (e.g., information relating to a location of interest to the user, a user interface screen having user interface elements which are selectable by the user, etc.). Navigational information can include, but is not limited to, one or more of a map of a geographic area, an immersive view of a location (e.g., a three-dimensional immersive video, a fly-through immersive video of a location, etc.), the position of the computing device 100 in the geographic area, a route through the geographic area designated on the map, one or more navigational directions (e.g., turn-by-turn directions through the geographic area), travel time for the route through the geographic area (e.g., from the position of the computing device 100 to a POI), and one or more points-of-interest within the geographic area.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. According to various examples of the disclosure, the output device 170 may include a speaker which outputs sound which is associated with a location in response to a user inputting a query relating to a location.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like) of a location. For example, the capture device 180 can include a sound capturer 184 (e.g., a microphone) which is configured to capture sound or audio (e.g., an audio recording) of a location. The media content captured by the capture device 180 may be transmitted to one or more of the server computing system 300, user-generated content data store 350, machine-generated content data store 360, POI data store 370, navigation data store 380, user data store 390, and machine-learned model data store 395, for example, via network 400. For example, in some implementations imagery may be used to generate a video and in some implementations the media content can be provided as an input to a generative machine-learned model to generate a video relating to a location, as an input to a NeRF for generating a video relating to the location, etc.

In accordance with example embodiments described herein, the server computing system 300 can include one or more processors 310 and one or more memory devices 320 which were previously discussed above. The server computing system 300 may also include a navigation and mapping system 330.

For example, the navigation and mapping system 330 may include a generative video application 332 which performs functions similar to those discussed above with respect to generative video application 132.

For example, the navigation and mapping system 330 may include a 3D scene generator which is configured to generate a 3D scene based on a plurality of images of a location (e.g., of the inside of a restaurant, of a park, etc.). The plurality of images may be captured and combined using known methods to create a 3D scene of the location. For example, server computing system 300 may be configured to generate a 3D scene or video based on a plurality of images of a location (e.g., of the inside of a restaurant, of a park, etc.). The plurality of images may be captured and combined using 3D reconstruction methods, computer vision methods, etc. For example, images which overlap with one another may be stitched together to create a 3D model of the scene. In some implementations, a method including a structure from motion algorithm can be used to estimate a three-dimensional structure. In some implementations, a multi-view stereo method may be implemented to generate a dense 3D point cloud by identifying corresponding points in multiple images and then triangulating their 3D positions. In some implementations, depth sensing methods may be implemented to determine or estimate a depth of each pixel in an image (e.g., using depth-sensing cameras, LiDAR, etc.) to generate depth maps which can be used to create a 3D point cloud or mesh representation of a scene. In some implementations, a machine learning resource (e.g., a neural radiance field) may be implemented to generate a camera-like image from any viewpoint within the location based on the captured images. For example, video flythroughs of the location may be generated based on the captured images. In some implementations, the initial 3D scene may be a static 3D scene which is devoid of variable or dynamic (e.g., moving) objects. For example, the initial 3D scene of a park may include imagery of the park including imagery of trees, playground equipment, picnic tables, and the like, without imagery of humans, dogs, or non-static objects. In some implementations, the initial 3D scene may be a 3D scene which includes one or more variable or dynamic (e.g., moving) objects. User generated content may include imagery of the variable or dynamic objects, where the imagery may be associated with different times and/or conditions (e.g., different times of the day, week, or year, different lighting conditions, different environmental conditions, etc.). In some implementations, one or more machine-learned models may be configured to generate content to be included in a video generated by one or more other machine-learned models.

For example, the navigation and mapping system 330 may store a plurality of 3D scenes and/or videos which are generated using one or more machine-learned models (e.g., generative machine-learned models). The 3D scenes and/or videos may be categorized or classified according to a time of day, a time of year, weather conditions, lighting conditions, etc. For example, navigation data store 380 may be configured to store videos which are generated using one or machine-learned models stored at machine-learned model data store 395. An example video may include a video which is associated with a particular park at noon in sunny conditions where several children are playing on playground equipment. In some implementations, the server computing system 300 may be configured to retrieve the video from the navigation data store 380 when the video is responsive to a query from a user requesting a video of a park near them which is fun for children, where the query may be received at midday. In some implementations, audio content may also be provided with the video. For example, audio recorded at the park at noon may include the laughter of children and may be included in the video.

In some implementations, the server computing system 300 may be configured to generate a video (e.g., in real-time) which is responsive to a query from a user requesting a video of a park near them which is fun for children, where the query may be received at midday. In some implementations, audio content may also be generated and provided with the video. For example, the generative video application 332 may be configured to generate a video with sound using audio recorded at the park which is relevant to the query (e.g., using audio recorded at the park at noon rather than at night). The generated video may provide the user viewing the video with an accurate representation of the state of the park at a relevant time of day, as well as an increased sense of how the park generally feels at that time of day, for example in similar weather and noise conditions.

For example, the navigation and mapping system 330 may be configured to generate graphical representations of dynamic objects (e.g., based on images provided in user-generated imagery stored at user-generated content data store 350 or based on images from other external sources). For example, the navigation and mapping system 330 may be configured to convert user-generated media content to a generic form to anonymize the media content (e.g., by converting a real-world image of a person positioned at a location to a two-dimensional or three-dimensional digital avatar which represents the person). For example, the sensor data obtained by the one or more sensors may indicate how many people are present at a location (e.g., based on the number of smartphones or other computing devices detected at the location). For example, the sensor data obtained by the one or more sensors may indicate various features about the people at the location (e.g., clothing, facial expressions, etc. based on an image captured by a camera, for example). For example, navigation and mapping system 330 may generate graphical representations of the people at the location according to the number of people and according to the features about the people at the location, to accurately represent the location and depict a vibe at the location. For example, images of a crowd in a stadium may include various people wearing jerseys associated with the home team. Navigation and mapping system 330 may generate graphical representations of the people at the stadium according to the number of people at the stadium and wearing similar jerseys or sportswear (as opposed to formal clothing), to accurately represent the location and depict a vibe at the location.

For example, navigation and mapping system 330 may be configured to generate audio content based on a portion (e.g., granular information) of recorded user-generated audio content or other available sound to create new audio content that remains representative of the state of the location at a particular time, as well as the mood, atmosphere, vibe, or feeling of the location at a particular time (e.g., time of day, time of week, time of year, etc.).

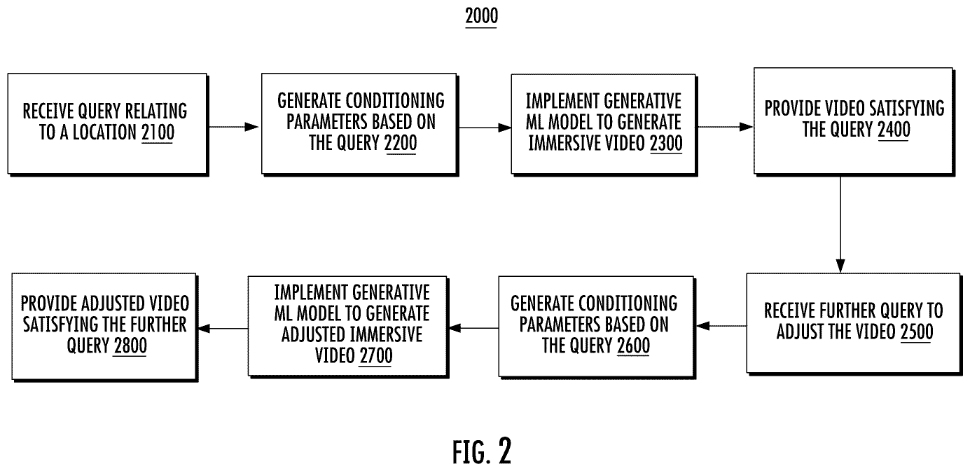

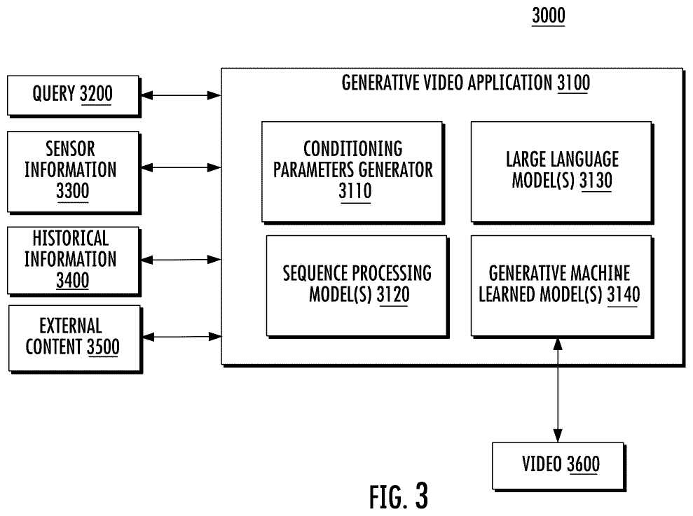

Examples of the disclosure are also directed to computer implemented methods for generating a video of a three-dimensional scene in response to receiving a user query and using one or more generative machine-learned models. FIG. 2 illustrates a flow diagram of an example, non-limiting computer-implemented method, according to one or more example embodiments of the disclosure. FIG. 3 illustrates a block diagram of a generative video application, according to one or more example embodiments of the disclosure.

The flow diagram of FIG. 2 illustrates a method 2000 for generating a video via a generative machine-learned model in response to receiving a query. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 2, at operation 2100 the method 2000 includes a computer platform receiving a query from a user relating to a location. As described herein, the computer platform may be embodied as computing device 100, server computing system 300, or combinations thereof. For example, the query may be provided by the user via input device 150. For example, the query may be in the form of a question, command, or description. For example, a user may provide a query to the computer platform relating to the location (e.g., a query such as “show me what the Palace of Fine Arts looks like on a Saturday in August”, or a query such as “what would the Palace of Fine Arts look like with a sea monster in the lagoon”). The query may be provided or input to navigation application 134, navigation application 334, generative video application 132, or generative video application 332, for example.

In some implementations, the query may be transmitted from computing device 100 to server computing system 300. For example, the query relating to the location may be associated with temporal conditions (e.g., a request relating to the location at a particular time, including a time of day, time of year, etc.) and/or other conditions including lighting conditions, weather conditions, and the like. For example, a user of computing device 100 may request an immersive view of a restaurant during the evening on a Friday (e.g., a voice input of “what's it like at dinner at Restaurant X on Friday?”) via generative video application 132 and the request may be transmitted to generative video application 332 at server computing system 300.

At operation 2200, the computer platform may be configured to, in response to receiving the query, generate conditioning parameters based at least in part on the query, wherein the conditioning parameters provide values for one or more conditions associated with a scene to be rendered at the location. For example, referring to FIG. 3, generative video application 3100 (which may correspond to generative video application 132 and/or generative video application 332) may include a conditioning parameters generator 3110, one or more sequence processing models 3120, one or more large language models 3130, and one or more generative machine-learned models 3140. The generative video application 3100 may receive a query 3200 from a user as discussed above with respect to operation 2100 of FIG. 2. Conditioning parameters generator 3110 may be configured to generate conditioning parameters based at least in part on the query, wherein the conditioning parameters provide values for one or more conditions associated with a scene to be rendered at the location.

To generate the conditioning parameters, the conditioning parameters generator 3110 may be configured to retrieve current values for the one or more conditions at the location. In some implementations, the conditioning parameters generator 3110 may be configured to retrieve current values for the one or more conditions at the location based on sensor information 3300 which may correspond to data output by one or more sensors. The one or more sensors may be provided at the computer platform or be provided externally (e.g., sensors disposed at the location). For example, current values associated with temperature data, lighting data, noise data, etc., may be retrieved by the conditioning parameters generator 3110 for various conditions (e.g., a temperature condition, a lighting condition, a noise condition, etc.) at the location.

To generate the conditioning parameters, the conditioning parameters generator 3110 may be configured to extract the values for the one or more conditions from the query. The query may include information indicative of the user's intent or requirements. In some implementations, the conditioning parameters generator 3110 (or the one or more sequence processing models 3120 or the one or more large language models 3130) may be configured to extract information from the query 3200 to identify values for the one or more conditions at the location, and the conditioning parameters generator 3110 may be configured to generate the conditioning parameters based on the extracted values. For example, the query itself may identify a time or day (e.g., “noon” or “Friday”) that can be used to generate the conditioning parameters.

To generate the conditioning parameters, the conditioning parameters generator 3110 may be configured to infer the values for the one or more conditions from the query. The query may include information indicative of the user's intent or requirements. In some implementations, the conditioning parameters generator 3110 (or the one or more sequence processing models 3120 or the one or more large language models 3130) may be configured to infer information from the query 3200 to identify values for the one or more conditions at the location, and the conditioning parameters generator 3110 may be configured to generate the conditioning parameters based on the inferred values. For example, the query may include a reference to a “crowded bar” and the conditioning parameters generator 3110 (or the one or more sequence processing models 3120 or the one or more large language models 3130) may be configured to infer that a bar which is at least 80% full compared to a known capacity of the bar can be considered to be crowded. Thus, the inferred value in the given example may correspond to an occupancy of the bar that is 80% full (e.g., 80 people or more given an occupancy limit of 100 people). Thus, to generate a video showing a crowded bar, the generative video application 3100 may be configured to generate a video that shows enough people inside the bar satisfying the user's intent of a “crowded” bar.

In some implementations, the conditioning parameters generator 3110 may be configured to infer the values for the one or more conditions from the query by providing the query to one or more sequence processing models 3120, wherein the one or more sequence processing models 3120 are configured to output the values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

The one or more sequence processing models 3120 may receive an input including text and tokenize the input by breaking down the sequence of text into small units (tokens) to provide a structured representation of the input sequence. The one or more sequence processing models 3120 may represent the tokens as vectors in a continuous vector space by mapping each token to a high-dimensional vector, where the relationships between tokens (words) are reflected in the geometric relationships between their corresponding vector. For example, the one or more sequence processing models 3120 may receive an input including the text “park at night” and tokenize the input by breaking down the sequence of text into small units (tokens) (e.g., “park,” “at,” and “night”), thereby providing a structured representation of the input sequence. In a word embedding, semantically similar words are closer together in the vector space. For example, the vectors for “park” and “playground” might be close to each other because of their semantic relationship, while the vectors for “day” and “night” may be far apart compared to the vectors for “night” and “evening”.

For example, the query may include a request to show a video relating to a particular bar when it is crowded and the one or more sequence processing models 3120 may be configured to tokenize and embed the query and infer a value for a “crowded” bar based on the query, based on semantic relationships with other vectors in the vector space, and based on other data that is represented as vectors in the vector space (e.g., input sequence data which may include raw data relating to what may generally be considered as a crowded bar) to infer that a bar which is at least 80% full compared to a known capacity of the bar can be considered to be crowded.

To generate the conditioning parameters, the conditioning parameters generator 3110 may be configured to predict future values for the one or more conditions based on current values for the one or more conditions at the location and/or based on historical values for the one or more conditions at the location. The query may include information indicative of the user's intent or requirements. In some implementations, the conditioning parameters generator 3110 (or the one or more sequence processing models 3120 or the one or more large language models 3130) may be configured to predict future values for the one or more conditions at the location, and the conditioning parameters generator 3110 may be configured to generate the conditioning parameters based on the predicted future values. For example, the query may indicate that the user would like a representation of a location at a future time or date, and the conditioning parameters generator 3110 (or the one or more sequence processing models 3120 or the one or more large language models 3130) may be configured to predict values for the one or more conditions at the location according to the query. In some implementations, the conditioning parameters generator 3110 may be configured to retrieve current values for the one or more conditions at the location based on sensor information 3300 which may correspond to data output by one or more sensors or based on external content 3500 (e.g., information extracted from websites or other sources of information). The one or more sensors may be provided at the computer platform or be provided externally (e.g., sensors provided at external computing devices disposed at the location). For example, current values associated with temperature data, lighting data, noise data, etc., may be retrieved by the conditioning parameters generator 3110 for various conditions (e.g., a temperature condition, a lighting condition, a noise condition, etc.) at the location. In some implementations, the conditioning parameters generator 3110 may be configured to retrieve historical values for the one or more conditions at the location based on historical information 3400 which may be stored at various computing devices (e.g., one or more of computing device 100, external computing device 200, server computing system 300, external content 500, POI data store 370, user data store 390, etc.). For example, historical values associated with temperature data, lighting data, noise data, etc., may be retrieved by the conditioning parameters generator 3110 for various conditions (e.g., a temperature condition, a lighting condition, a noise condition, etc.) at the location.

For example, the generative video application 3100 (e.g. conditioning parameters generator 3110) may be configured to implement one or more machine-learned models to predict future values for one or more conditions based on current values and/or historical values for the one or more conditions For example, the generative video application 3100 may be configured to utilize one or more forecasting methods (e.g., linear regression, autoregressive-integrated moving average models, exponential smoothing state space models) and/or neural networks (long short-term memory networks, gated recurrent unit networks, feedforward neural networks, etc.) for predicting values for the one or more conditions based on current values and/or historical values for the one or more conditions. Thus, to generate a video showing a particular condition, (e.g., an anticipated size of a crowd at a concert at an outdoor venue) according to one or more predicted future values, the generative video application 3100 may be configured to generate a video that depicts a scene based on a predicted future values for one or more conditions (e.g., a predicted value for a crowd based on historical attendance information and current ticket sales, and a predicted value for weather based on historical weather information and current weather information).

At operation 2300, the computer platform may be configured to generate, using one or more generative machine-learned models, the video, wherein the video depicts the scene at the location (e.g., a video showing an interior of a location, an exterior of the location, aerial views of the location, etc.) and with the values for the one or more conditions. For example, generative video application 3100 may be configured to generate, using the one or more generative machine-learned models 3140, the video 3600.

The one or more generative machine-learned models 3140 may include a deep neural network or a generative adversarial network (GAN) to generate the video that depicts the scene at a particular location with values for conditions associated with that scene. For example, the computer platform may include a database (e.g., machine-learned model data store 395) which is configured to store a plurality of generative machine-learned models respectively associated with a plurality of different locations. The computer platform may be configured to retrieve, from among the one or more generative machine-learned models 3140, a generative machine-learned model associated with a particular location relating to the query.

In some implementations, the one or more generative machine-learned models 3140 may be trained on a large dataset of videos or frames of scenes with corresponding information about the conditions associated with each scene. These conditions could include variables like time of day, weather, lighting, object placement, etc. During training, the one or more generative machine-learned models 3140 learn relationships between the visual elements in a scene and conditions that influence them. This may involve the computer platform adjusting each generative machine-learned model's internal parameters to generate realistic scenes based on the training data. The one or more generative machine-learned models 3140 may be trained on one or more training datasets including a plurality of reference images of the location. The one or more training datasets may include values for the one or more conditions for at least some of the plurality of reference images.

In some implementations, the one or more generative machine-learned models 3140 are configured to generate the video 3600 frame by frame, based on the location as indicated in the query and the values for one or more conditions associated with the scene to be rendered at the location. For example, the one or more generative machine-learned models 3140 may be configured to generate an initial frame and generate subsequent frames based on the conditions specified. For example, the one or more generative machine-learned models 3140 may be configured to generate a series of camera poses based at least in part on the query. For example, the one or more generative machine-learned models 3140 may be configured to render, respectively from the series of camera poses, a series of images of the scene at the location and with the values for the one or more conditions. For example, if the query indicates a sunset scene, the one or more generative machine-learned models 3140 may be configured to gradually change the lighting, shadows, and colors in the scene to simulate the progression from day to sunset. The video 3600 may be formed by a series of images of the scene where at least some of the images may be from different camera poses. The one or more generative machine-learned models 3140 may be configured to generate the video 3600 by conditioning the one or more generative machine-learned models 3140 with the conditioning parameters. For example, the one or more generative machine-learned models 3140 may be configured to consider the conditioning parameters (and corresponding values for the one or more conditions) to make decisions for rendering the scene at each frame. For example, the one or more generative machine-learned models 3140 may be configured to adjust (for each frame of the video 3600) the position of the sun, the colors of the sky and water, and the placement of objects on the beach, in accordance with the specified conditions, making the scene and video 3600 appear realistic and/or coherent. For example, the one or more generative machine-learned models 3140 may be configured to continue the frame-by-frame generation process until the entire video sequence has been created. The one or more generative machine-learned models 3140 may be configured to output the video 3600 that depicts the scene at the location with the values for conditions associated with that scene, matching the criteria provided in the input query 3200 and conditioning parameters generated by the conditioning parameters generator 3110. In some implementations, the computer platform may be configured to implement post-processing operations to enhance the quality of the video 3600, add special effects, or fine-tune details.

For example, the one or more generative machine-learned models 3140 may include a neural radiance field (NeRF). A NeRF may be implemented via a fully-connected neural network to generate novel views of complex 3D scenes, based on a partial set of 2D images to generate 3D representations of an object or scene from 2D images. For example, the fully-connected neural network may be configured to predict the light intensity (or radiance which includes color and lighting) at any point in a 2D image to generate novel 3D views from different angles. For example, the fully-connected neural network may be configured to take input images representing a scene and interpolate between them to render a complete scene.

At operation 2400, the computer platform may be configured to provide the video 3600 satisfying the input query 3200. For example, the query may include a text query that specifies one or more objects to be included in the scene and the video 3600 which is generated may depict the one or more objects included in the scene. For example, the video 3600 may be provided for presentation on the display device 160 of computing device 100. In some implementations, the server computing system 300 may provide (transmit) the video 3600 to computing device 100 or the server computing system 300 may provide access to the video 3600 to computing device 100. For example, the generated video 3600 may be stored at one or more computing devices (e.g., one or more of computing device 100, external computing device 200, server computing system 300, external content 500, POI data store 370, user data store 390, etc.).

In some implementations, the computer platform (e.g., generative video application 3100) may also integrate or provide audio content with the video 3600. For example, the computer platform may provide audio content with the video 3600 according to information (e.g., temporal information, user-specified information, user-preference information, etc.) associated with the scene. In some implementations, the computer platform (e.g., generative video application 3100) may be configured to integrate user-generated content from user-generated content data store 350 and/or machine-generated content from machine-generated content data store 360 with the video at operation 2300. The integration of the audio content can provide a user viewing the video with an even more accurate representation of the state of the location at a particular time or under other specified conditions. Further, the integration of audio content may also provide a further sense of how the location generally feels or sounds at a particular time (e.g., a time of day, time of year, etc.) or under other specified conditions (e.g., a particular weather condition, etc.).

At operation 2500 the method 2000 includes the computer platform receiving a further query from the user relating to the video (e.g., to adjust the video). For example, the further query may be provided by the user via input device 150. For example, the further query may be in the form of a question, command, or description. For example, the user may provide the further query to the computer platform relating to the video (e.g., a query requesting that the video be shown from a different viewpoint such as “show me what the Palace of Fine Arts looks like from an aerial view” when it is initially provided from a ground view, or a query such as “show me what is behind the door” when the initial video shows a structure with a door and the user wants to know what is behind the door). The query may be provided or input to navigation application 134, navigation application 334, generative video application 132, or generative video application 332, for example.

Operations 2600 and 2700 of method 2000 are similar to operations 2200 and 2300 already described herein and therefore detailed descriptions of operations 2600 and 2700 will not be described in detail for the sake of brevity. For example, at operation 2600, the computer platform may be configured to, in response to receiving the further query, generate conditioning parameters based at least in part on the further query, wherein the conditioning parameters provide values for one or more conditions associated with a scene to be rendered at the location. For example, the conditioning parameters may relate to a context concerning one or more conditions relating to the video to be adjusted (e.g., from a different viewpoint, an object in the video, portions of the video which obscure or hide objects in the scene, changes to lighting of the video, etc.). For example, values for the one or more conditions can be provided as described herein.

At operation 2700 the computer platform may be configured to generate, using the one or more generative machine-learned models, an adjusted video, wherein the adjusted video depicts the location in accordance with the query (e.g., an updated video from an aerial viewpoint, an updated video showing a scene behind the door which was not previously visible to the user in the initial video, etc.) and with the values for the one or more conditions.

According to some implementations of the disclosure, the computer platform (e.g., generative video application 3100) may be configured to utilize a neural network to render the updated video showing a condition of a location where the computer platform implements a NeRF to generate simulated information (e.g., imagery, frames, etc.) for the updated video from various viewpoints (e.g., from the air, from different angles, with different lighting, etc.) such that the computer platform can dynamically respond to the further query. For example, as the initial video provided at operation 2400 is being displayed to the user, the user can provide the further query at operation 2500 to request an adjusted video from a different viewpoint not visible in the video and the NeRF can generate imagery for the updated video that shows a possible depiction of the scene relating to the further query. For example, the computer platform may be configured to dynamically adjust to the further query and to dynamically generate an adjusted video via operations 2600 and 2700 using NeRF in which a scene in the adjusted video is shown with imagery responsive to the further query (e.g., with adjusting lighting, adjusted viewpoint, with a viewpoint of a scene previously not visible, etc.). Thus, in some implementations information about a location that is not viewable by the user in the initial generated video may be presented for display to the user in the adjusted video. Imagery may be generated via the one or more generative machine-learned models 3140 as needed to provide a smooth movement of the video (e.g., 24 frames per second, 30 frames per second, 60 frames per second, etc.) within an immersive view of the location to bring the location to life and to accurately represent the state of the location at a particular time and/or under particular condition(s).

At operation 2800, the computer platform may be configured to provide the adjusted video satisfying the further query. For example, the updated video may be provided for presentation on the display device 160 of computing device 100. In some implementations, the server computing system 300 may provide (transmit) the updated video to computing device 100 or the server computing system 300 may provide access to the updated video to computing device 100. For example, the updated video may be stored at one or more computing devices (e.g., one or more of the computing device 100, external computing device 200, server computing system 300, external content 500, POI data store 370, user data store 390, etc.).

In the examples described with respect to FIGS. 2 and 3, the computer platform may dynamically generate the video 3600 relating to the location in response to receiving the query at operation 2100. In some implementations however, a video which satisfies the request received at operation 2100 may be prestored or preexisting and may be stored at one or more computing devices (e.g., one or more of computing device 100, external computing device 200, server computing system 300, external content 500, POI data store 370, user data store 390, etc.). Therefore, in such a case operations 2200 and 2300 may be omitted while an operation of searching for the video which satisfies the conditions of the query may be performed as an intermediate operation between operations 2100 and 2400. Accordingly, the responsiveness of the computer platform to the request may be faster as less operations are performed or needed.

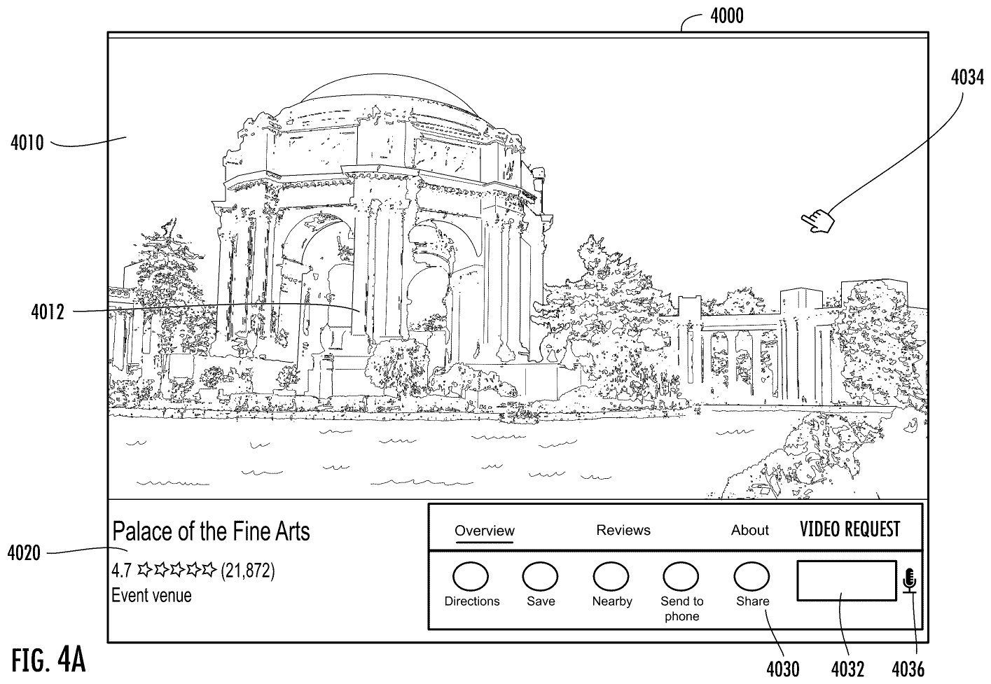

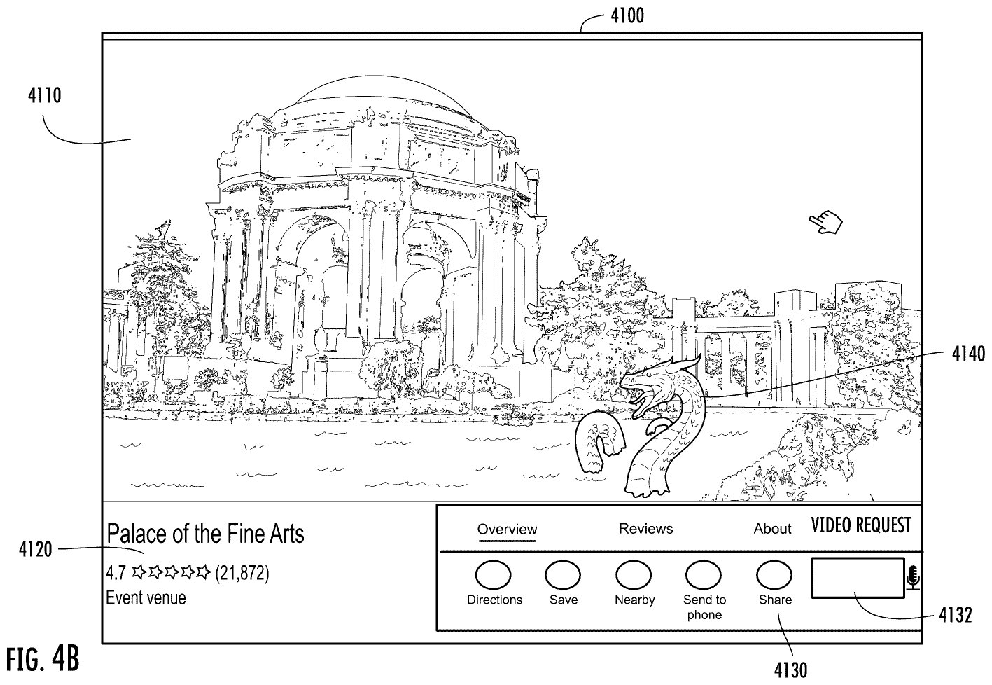

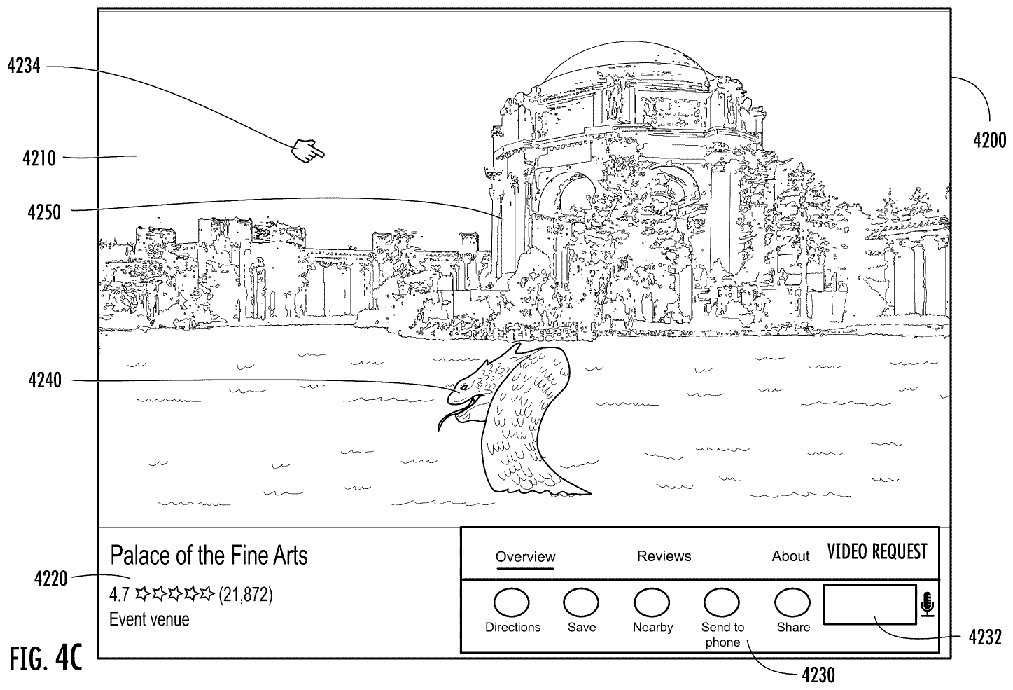

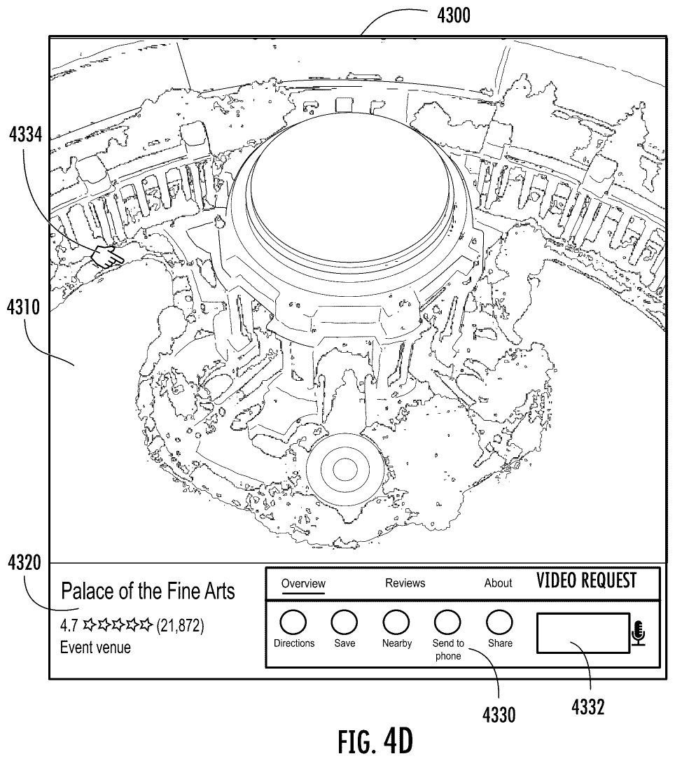

Examples of the disclosure are also directed to user-facing aspects by which a user can request an immersive video relating to a location. For example, FIGS. 4A through 4D illustrate portions of an example video relating to a location which can be presented on a display device associated with a user, according to one or more example embodiments of the disclosure.

For example, FIG. 4A illustrates a user interface screen of a mapping or navigation application, according to one or more example embodiments of the disclosure. In FIG. 4A, user interface screen 4000 includes a first portion 4010 which displays a video of a location, a second portion 4020 which displays information about the location, and a third portion 4030 which includes various user interface elements including a first user interface element 4032 for providing an input to request a video relating to a location. For example, in FIG. 4A the video relates to the location of the Palace of Fine Arts. First user interface element 4032 may be configured to enable a user to obtain an immersive video relating to a location. For example, first user interface element 4032 may be in the form of a text box to enable a user to enter a query (e.g., in text form). However, the user may provide a query via other methods (e.g., via selection from a pull-down menu, via a voice input through a microphone 4036, etc.). In some implementations, manipulation of an input device (e.g., a mouse, a touchscreen, etc.) via a cursor (or pointer) 4034 may cause a viewpoint of the video to be changed (e.g., through rotation of a scene).

In accordance with the embodiments described herein, the video displayed in the first portion 4010 may be generated in response to receiving a query as described with respect to FIGS. 2 and 3. For example, the query given by the user may request a video showing the Palace of Fine Arts in the morning and the generative video application 3100 may be configured to generate the video as shown in FIG. 4A in accordance with the embodiments as described with respect to FIGS. 2 and 3.

For example, FIG. 4B illustrates a user interface screen of a mapping or navigation application, according to one or more example embodiments of the disclosure. In FIG. 4B, user interface screen 4100 includes a first portion 4110 which displays a video of a location, a second portion 4120 which displays information about the location, and a third portion 4130 which includes various user interface elements including a first user interface element 4132 for providing an input to request a video relating to a location. For example, the video shown in FIG. 4A may be dynamically modified in response to receiving a further query from the user (e.g., requesting a video showing a sea monster in the lagoon). The generative video application 3100 may be configured to generate the video as shown in FIG. 4B which includes the sea monster 4140, in accordance with the embodiments as described with respect to FIGS. 2 and 3.

For example, FIG. 4C illustrates a user interface screen of a mapping or navigation application, according to one or more example embodiments of the disclosure. In FIG. 4C, user interface screen 4200 includes a first portion 4210 which displays a video of a location, a second portion 4220 which displays information about the location, and a third portion 4230 which includes various user interface elements including a first user interface element 4232 for providing an input to request a video relating to a location. For example, the video shown in FIG. 4B may be dynamically modified in response to receiving a further query from the user (e.g., requesting a video showing a different view of the sea monster in the lagoon). The generative video application 3100 may be configured to generate the video as shown in FIG. 4C which includes a depiction of the sea monster 4240 from a different viewpoint or angle, in accordance with the embodiments as described with respect to FIGS. 2 and 3. For example, scenes from the video may be generated by implementing a neural radiance field (NeRF) to generate novel views of the scene, based on a partial set of 2D images relating to the location and/or objects at the location to generate 3D representations of the location and/or objects at the location (e.g., novel views of the sea monster 4240, of the structure 4250, etc.).

For example, FIG. 4D illustrates a user interface screen of a mapping or navigation application, according to one or more example embodiments of the disclosure. In FIG. 4D, user interface screen 4300 includes a first portion 4310 which displays a video of a location, a second portion 4320 which displays information about the location, and a third portion 4330 which includes various user interface elements including a first user interface element 4332 for providing an input to request a video relating to a location. For example, the video shown in FIG. 4A may be dynamically modified in response to receiving a further query from the user (e.g., requesting a video showing a different view of the Palace of Fine Arts). The generative video application 3100 may be configured to generate the video as shown in FIG. 4D which includes a depiction of the Palace of Fine Arts from a different viewpoint or angle (e.g., from an overhead or aerial view of the Palace of Fine Arts), in accordance with the embodiments as described with respect to FIGS. 2 and 3. For example, scenes from the video may be generated by implementing a neural radiance field (NeRF) to generate novel views of the scene, based on a partial set of 2D images relating to the location and/or objects at the location to generate 3D representations of the location and/or objects at the location (e.g., novel views of the Palace of Fine Arts from an overhead view).

According to some implementations of the disclosure, the computer platform (e.g., generative video application 3100) may be configured to utilize a neural network to render a video showing a condition of a location where a NeRF can be implemented to generate simulated information (e.g., imagery, frames, etc.) for a video from various viewpoints (e.g., from the air, from different angles, etc.) such that the computer platform can dynamically respond to user queries and inputs. For example, as a video is being displayed to the user, the user can provide a further query (input) to request an updated video from a different viewpoint not visible in the video and the NeRF can generate imagery for an updated video that shows a possible depiction of the scene relating to the query. For example, if a user requests an updated video which shows what it looks like behind one of the pillars 4012 in FIG. 4A, the computer platform may be configured to dynamically adjust to the query and to dynamically generate an updated video using NeRF in which a scene in the video is shown with imagery of a possible depiction of the scene behind the pillar, for example, based on simulated data or simulated information. Therefore, information about a location that is not viewable by the user in the initial generated video may be presented for display to the user in the updated generated video. Imagery may be generated as needed to provide a smooth movement of the video (e.g., 24 frames per second, 30 frames per second, 60 frames per second, etc.) within an immersive view of the location to bring the location to life and to accurately represent the state of the location at a particular time and/or under particular condition(s).

Though not shown in FIGS. 4A-4D, other user interface elements may be provided by which a user can specify a request to obtain an immersive video relating to a location according to various conditions or inputs to accurately obtain a representation of the state of the location according to those conditions or inputs as indicated in a query from the user. Further, this may allow a user to accurately obtain a state (e.g., vibe) of the location according to those conditions. For example, a user interface element for identifying a weather condition (e.g., a sunset view, a sunrise view, under sunny, cloudy, or rainy conditions, etc.) may be provided. For example, a user of the computing device 100 may request an immersive video of a park in the evening when it is raining. The user interface element to specify a weather condition (or any condition associated with the requested immersive video) may be in the form of a pull-down menu, a selectable user interface element, a text box, and the like. For example, a user interface element for specifying a crowd condition (e.g., not crowded, slightly crowded, crowded, very crowded, etc.) may be provided. For example, a user of the computing device 100 may request an immersive video of a park when it is considered to be very busy so that the user can appreciate the state or vibe of the park when it is very crowded without actually traveling to the park. The video may be generated via one or more generative machine-learned models as described herein and include a plurality of image frames of the park with a high level of visitors and/or audio content which reflects a very noisy environment indicative of a very crowded park. As described herein, a high level may be defined with respect to a threshold level (e.g., more than a predetermined percentage of a capacity of the park, more than a specified number of people, etc.), a user-specified standard, etc. For example, a user interface element for specifying a lighting condition (e.g., normal ambient light, bright, dark, etc.) may be provided. For example, a user of the computing device 100 may request an immersive video relating to a park when it is considered to be very bright so that the user can appreciate the state (e.g., ambiance) of the park when it is very bright without actually traveling to the park. For example, the video of the park may include imagery indicative of the park under bright conditions. As described herein, a high level of brightness may be defined with respect to a threshold level (e.g., more than a predetermined luminance level), a user-specified standard, etc. The user may also specify a time of day in addition to or instead of a brightness level, when requesting the immersive video.

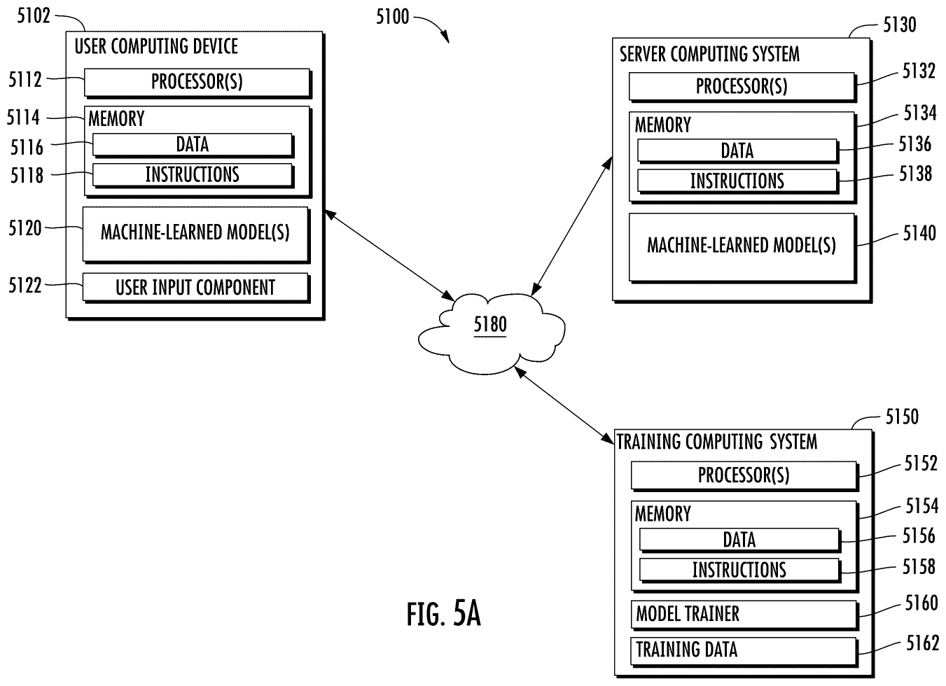

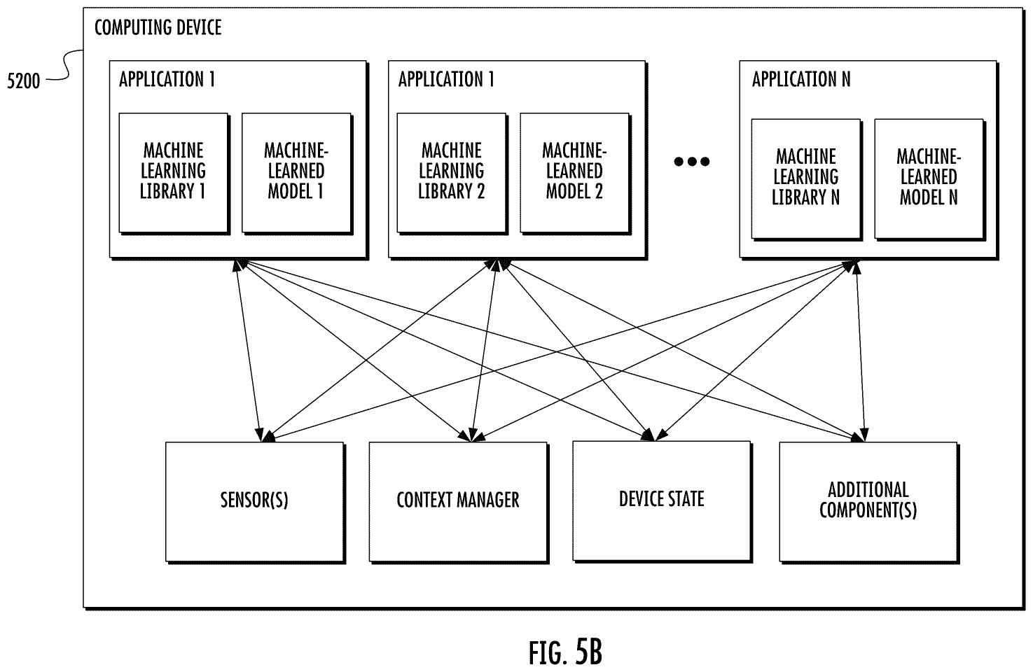

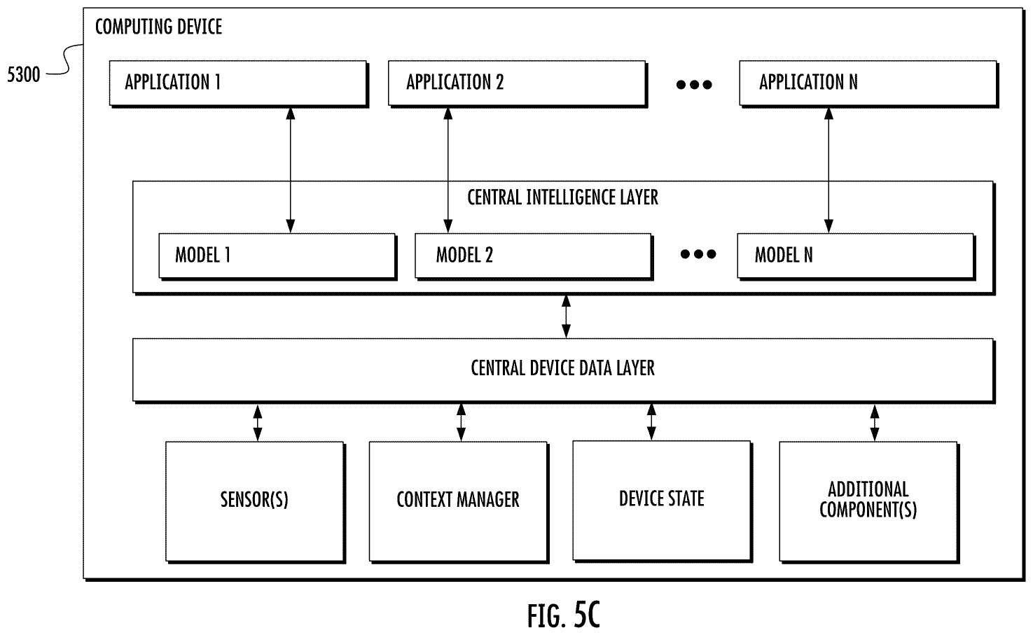

FIG. 5A depicts a block diagram of an example computing system for generating a video via a generative machine-learned model in response to receiving a query, according to one or more example embodiments of the disclosure. The system 5100 includes a user computing device 5102, a server computing system 5130, and a training computing system 5150 that are communicatively coupled over a network 5180.

FIG. 5B depicts a block diagram of an example computing device for generating a video via a generative machine-learned model in response to receiving a query, according to one or more example embodiments of the disclosure.

FIG. 5C depicts a block diagram of an example computing device for generating a video via a generative machine-learned model in response to receiving a query, according to one or more example embodiments of the disclosure.

The user computing device 5102 (which may correspond to computing device 100) can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 5102 includes one or more processors 5112 and a memory 5114. The one or more processors 5112 can be any suitable processing device (e.g., a processor core, a microprocessor, an ASIC, an FPGA, a controller, a microcontroller, etc.) and can be one processor or a plurality of processors that are operatively connected. The memory 5114 can include one or more non-transitory computer-readable storage media, such as RAM, ROM, EEPROM, EPROM, flash memory devices, magnetic disks, etc., and combinations thereof. The memory 5114 can store data 5116 and instructions 5118 which are executed by the processor 5112 to cause the user computing device 5102 to perform operations.

In some implementations, the user computing device 5102 can store or include one or more machine-learned models 5120 (e.g., large language models, sequence processing models, generative machine-learned models, etc.). For example, the one or more machine-learned models 5120 can be or can otherwise include various machine-learned models such as neural networks (e.g., deep neural networks) or other types of machine-learned models, including non-linear models and/or linear models. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models (e.g., transformer models). Example machine-learned models were discussed with reference to FIGS. 1A through 4D.

In some implementations, the one or more machine-learned models 5120 can be received from the server computing system 5130 over network 5180, stored in the memory 5114, and then used or otherwise implemented by the one or more processors 5112. In some implementations, the user computing device 5102 can implement multiple parallel instances of a single machine-learned model (e.g., to perform parallel tasks across multiple instances of the machine-learned model). In some implementations, the task is a generative task and one or more machine-learned models may be implemented to output content (e.g., videos) in view of various inputs (e.g., a query, conditioning parameters, etc.). More particularly, the machine-learned models disclosed herein (e.g., including large language models, sequence processing models, generative machine-learned models, etc.), may be implemented to perform various tasks related to an input query.

According to examples of the disclosure, a computing system may implement one or more sequence processing models 3120 as described herein to output values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

According to examples of the disclosure, a computing system may implement one or more large language models 3130 to determine a plurality of variables based on the query. For example, a large language model may include a Bidirectional Encoder Representations from Transformers (BERT) large language model. The large language model may be trained to understand and process natural language for example. The large language model may be configured to extract information from the query to identify keywords, intents, and context within the query to determine a plurality of variables for generating the video. The variables may include latent variables that represent an underlying structure of the language.

According to examples of the disclosure, a computing system may implement one or more generative machine-learned models 3140 to generate the video that depicts the scene at a particular location with values for conditions associated with that scene. The one or more generative machine-learned models 3140 may include a deep neural network or a generative adversarial network (GAN) to generate the video that depicts the scene at a particular location with values for conditions associated with that scene. For example, the one or more generative machine-learned models 3140 may include a neural radiance field (NeRF). A NeRF may be implemented via a fully-connected neural network to generate novel views of complex 3D scenes, based on a partial set of 2D images to generate 3D representations of an object or scene from 2D images. For example, the fully-connected neural network may be configured to predict the light intensity (or radiance which includes color and lighting) at any point in a 2D image to generate novel 3D views from different angles. For example, the fully-connected neural network may be configured to take input images representing a scene and interpolate between them to render a complete scene.

Additionally, or alternatively, one or more machine-learned models 5140 can be included in or otherwise stored and implemented by the server computing system 5130 that communicates with the user computing device 5102 according to a client-server relationship. For example, the one or more machine-learned models 5140 can be implemented by the server computing system 5130 as a portion of a web service (e.g., a navigation service, a mapping service, and the like). Thus, one or more machine-learned models 5120 can be stored and implemented at the user computing device 5102 and/or one or more machine-learned models 5140 can be stored and implemented at the server computing system 5130.

The user computing device 5102 can also include one or more user input components 5122 that receives user input. For example, the user input component 5122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 5130 (which may correspond to server computing system 300) includes one or more processors 5132 and a memory 5134. The one or more processors 5132 can be any suitable processing device (e.g., a processor core, a microprocessor, an ASIC, an FPGA, a controller, a microcontroller, etc.) and can be one processor or a plurality of processors that are operatively connected. The memory 5134 can include one or more non-transitory computer-readable storage media, such as RAM, ROM, EEPROM, EPROM, flash memory devices, magnetic disks, etc., and combinations thereof. The memory 5134 can store data 5136 and instructions 5138 which are executed by the processor 5132 to cause the server computing system 5130 to perform operations.

In some implementations, the server computing system 5130 includes or is otherwise implemented by one or more server computing devices. In instances in which the server computing system 5130 includes plural server computing devices, such server computing devices can operate according to sequential computing architectures, parallel computing architectures, or some combination thereof.

As described above, the server computing system 5130 can store or otherwise include one or more machine-learned models 5140. For example, the one or more machine-learned models 5140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models were discussed with reference to FIGS. 1A through 4D.

The user computing device 5102 and/or the server computing system 5130 can train the one or machine-learned models 5120 and/or 5140 via interaction with the training computing system 5150 that is communicatively coupled over the network 5180. The training computing system 5150 can be separate from the server computing system 5130 or can be a portion of the server computing system 5130.

The training computing system 5150 includes one or more processors 5152 and a memory 5154. The one or more processors 5152 can be any suitable processing device (e.g., a processor core, a microprocessor, an ASIC, an FPGA, a controller, a microcontroller, etc.) and can be one processor or a plurality of processors that are operatively connected. The memory 5154 can include one or more non-transitory computer-readable storage media, such as RAM, ROM, EEPROM, EPROM, flash memory devices, magnetic disks, etc., and combinations thereof. The memory 5154 can store data 5156 and instructions 5158 which are executed by the processor 5152 to cause the training computing system 5150 to perform operations. In some implementations, the training computing system 5150 includes or is otherwise implemented by one or more server computing devices.

The training computing system 5150 can include a model trainer 5160 that trains the one or more machine-learned models 5120 and/or 5140 stored at the user computing device 5102 and/or the server computing system 5130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 5160 can perform a number of generalization techniques (e.g., weight decays, dropouts, etc.) to improve the generalization capability of the models being trained.

In particular, the model trainer 5160 can train the one or more machine-learned models 5120 and/or 5140 based on a set of training data 5162. The training data 5162 can include, for example, various datasets which may be stored remotely or at the training computing system 5150. For example, in some implementations an example dataset utilized for training includes a plurality of videos relating to a particular location, a plurality of images relating to a particular location, etc. However, other datasets of images and videos may be utilized (e.g., images and videos from external websites). In some implementations, the dataset may be confined to a particular category, genre, landscape, time, etc. In some implementations, the dataset may contain diverse subject matter including objects, landscapes, individuals, groups of people, structures, etc.

In some implementations, if the user has provided consent, the training examples can be provided by the user computing device 5102. Thus, in such implementations, the one or more machine-learned models 5120 provided to the user computing device 5102 can be trained by the training computing system 5150 on user-specific data received from the user computing device 5102. In some instances, this process can be referred to as personalizing the model.

The model trainer 5160 includes computer logic utilized to provide desired functionality. The model trainer 5160 can be implemented in hardware, firmware, and/or software controlling a general purpose processor. For example, in some implementations, the model trainer 5160 includes program files stored on a storage device, loaded into a memory and executed by one or more processors. In other implementations, the model trainer 5160 includes one or more sets of computer-executable instructions that are stored in a tangible computer-readable storage medium such as RAM, hard disk, or optical or magnetic media.

The network 5180 can be any type of communications network, such as a local area network (e.g., intranet), wide area network (e.g., Internet), or some combination thereof and can include any number of wired or wireless links. In general, communication over the network 5180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

FIG. 5A illustrates an example computing system that can be used to implement aspects of the disclosure. Other computing systems can be used as well. For example, in some implementations, the user computing device 5102 can include the model trainer 5160 and the training data 5162. In such implementations, the one or more machine-learned models 5120 can be both trained and used locally at the user computing device 5102. In some of such implementations, the user computing device 5102 can implement the model trainer 5160 to personalize the one or more machine-learned models 5120 based on user-specific data.

FIG. 5B depicts a block diagram of an example computing device for generating a video via a generative machine-learned model in response to receiving a query, according to one or more example embodiments of the disclosure. The computing device 5200 can be a user computing device or a server computing device.

The computing device 5200 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device for generating a video via a generative machine-learned model in response to receiving a query, according to one or more example embodiments of the disclosure. The computing device 50 can be a user computing device or a server computing device.

The computing device 5300 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 5300.

The central intelligence layer can communicate with a central device data layer. The central device data layer can be a centralized repository of data for the computing device 5300. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

To the extent alleged generic terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer platform for generating a video, comprising:
one or more memories configured to store instructions; and
one or more processors configured to execute the instructions to perform operations, the operations comprising:
receiving a query from a user relating to a location;
in response to receiving the query, generating conditioning parameters based at least in part on the query, wherein the conditioning parameters provide values for one or more conditions associated with a scene to be rendered at the location;
generating, using a generative machine-learned model, the video, wherein the video depicts the scene at the location and with the values for the one or more conditions; and
providing the video for presentation to the user.

2. The computer platform of claim 1, wherein the generative machine-learned model comprises a neural radiance field (NeRF).

3. The computer platform of claim 1, wherein generating the conditioning parameters comprises retrieving current values for the one or more conditions at the location.

4. The computer platform of claim 1, wherein generating, using the generative machine-learned model, the video comprises conditioning the generative machine-learned model with the conditioning parameters.

5. The computer platform of claim 1, wherein generating the conditioning parameters comprises extracting the values for the one or more conditions from the query.

6. The computer platform of claim 1, wherein generating the conditioning parameters comprises inferring the values for the one or more conditions from the query.

7. The computer platform of claim 6, wherein inferring the values for the one or more conditions comprises providing the query to a sequence processing model, wherein the sequence processing model is configured to output the values for the one or more conditions in response to the query.

8. The computer platform of claim 1, further comprising implementing one or more large language models to determine a plurality of variables based on the query.

9. The computer platform of claim 1, wherein generating the conditioning parameters comprises predicting future values for the one or more conditions based on current values for the one or more conditions at the location and/or based on historical values for the one or more conditions at the location.

10. The computer platform of claim 1, wherein generating, using the generative machine-learned model, the video comprises:
generating a series of camera poses based at least in part on the query; and
rendering, respectively from the series of camera poses, a series of images of the scene at the location and with the values for the one or more conditions.

11. The computer platform of claim 1, wherein
the computer platform comprises a database configured to store a plurality of generative machine-learned models respectively associated with a plurality of different locations; and
generating, using the generative machine-learned model, the video comprises retrieving, from among the plurality of generative machine-learned models, the generative machine-learned model associated with the location.

12. The computer platform of claim 1, wherein the query comprises a text query that specifies one or more objects to be included in the scene and wherein the video depicts the one or more object included in the scene.

13. The computer platform of claim 1, wherein
the generative machine-learned model has been trained on a training dataset comprising a plurality of reference images of the location, and
the training dataset comprises values for the one or more conditions for at least some of the plurality of reference images.

14. The computer platform of claim 1, wherein the operations further comprise:
receiving a further query from the user relating to the video;
in response to receiving the further query, generating further conditioning parameters based at least in part on the further query, wherein the further conditioning parameters provide values for one or more further conditions associated with the scene to be rendered at the location;
generating, using the generative machine-learned model, an adjusted video, wherein the adjusted video depicts the scene at the location and with the values for the one or more further conditions; and
providing the adjusted video for presentation to the user.

15. A computer-implemented method for generating a video, comprising:
receiving a query from a user relating to a location;
in response to receiving the query, generating conditioning parameters based at least in part on the query, wherein the conditioning parameters provide values for one or more conditions associated with a scene to be rendered at the location;
generating, using a generative machine-learned model, the video, wherein the video depicts the scene at the location and with the values for the one or more conditions; and
providing the video for presentation to the user.

16. The computer-implemented method of claim 15, wherein the generative machine-learned model comprises a neural radiance field (NeRF).

17. The computer-implemented method of claim 15, wherein generating the conditioning parameters comprises:
retrieving current values for the one or more conditions at the location, or
predicting future values for the one or more conditions based on current values for the one or more conditions at the location and/or based on historical values for the one or more conditions at the location.

18. The computer-implemented method of claim 15, wherein generating the conditioning parameters comprises extracting the values for the one or more conditions from the query.

19. The computer-implemented method of claim 15, wherein generating the conditioning parameters comprises inferring the values for the one or more conditions from the query.

20. A non-transitory computer readable medium storing instructions which, when executed by a processor, cause the processor to perform operations for generating a video, the operations comprising:
receiving a query from a user relating to a location;
in response to receiving the query, generating conditioning parameters based at least in part on the query, wherein the conditioning parameters provide values for one or more conditions associated with a scene to be rendered at the location;
generating, using a generative machine-learned model, the video, wherein the video depicts the scene at the location and with the values for the one or more conditions; and
providing the video for presentation to the user.
